(19) United States
(12) Patent Application Publication
(10) Pub. No.: US 2018/0128981 A1
(43) Pub. Date: May 10, 2018

(54) SPATIAL MODE FILTERING DEVICES AND METHODS TO MITIGATE MODAL DISPERSION AND INCREASE DATA RATE IN A STEP-INDEX OPTICAL FIBER LINK

(71) Applicant: NUtech Ventures, Lincoln, NE (US)

(72) Inventor: Lim Nguyen, Bellevue, NE (US)

(21) Appl. No.: 15/807,473

(22) Filed: Nov. 8, 2017

Related U.S. Application Data
(60) Provisional application No. 62/419,871, filed on Nov. 9, 2016.

(51) Int. Cl. G02B 6/26; G02B 6/14; G02B 1/04; G02B 6/032

(52) U.S. Cl. CPC G02B 6/268; G02B 6/032; G02B 1/048; G02B 6/14

(57) ABSTRACT

An optical fiber (OF) spatial mode filter element includes a structure having an internal cylindrical volume and is adapted to connect an exit end of a first OF with an entrance end of a second OF. An index of refraction of the structure is greater than an index of refraction of a material within the internal cylindrical volume, and when disposed between the exit end of the first OF with the entrance end of the second OF a gap width of the hollow volume between the exit end of the first OF and the entrance end of the second OF defines an effective numerical aperture of the entrance end of the second OF.

### CROSS-REFERENCE TO RELATED APPLICATIONS

The present application claims the benefit under 35 U.S.C. § 119(e) of U.S. Provisional Application Ser. No. 62/419,871, filed Nov. 9, 2016, and titled “SPATIAL MODE FILTERING METHOD TO MITIGATE MODAL DISPERSION AND INCREASE DATA RATE IN A STEP-INDEX OPTICAL FIBER LINK” which is hereby incorporated by reference in its entirety.

### BACKGROUND

The present disclosure generally provides systems and methods for mitigating modal dispersion, and more particularly to systems and methods for mitigating modal dispersion in an optical fiber (OF) link, such as in a step-index plastic optical fiber (SI-POF) link or step-index silica optical fiber (SI-SOF) link.

SI-POF provides advantages compared to SOF and copper wires. SI-POF has a remarkable flexibility, has immunity to EMI, and offers simplicity of termination and connection. These advantages have led to the widespread deployment of SI-POF, e.g., in automobile or aircraft networking. As a result, there have been extensive research and development efforts to develop and standardize a 1 Gbps link over 50 m of standard 1 mm SI-POF.

A typical POF link comprises of transmitter (TX), transmission media and a receiver (RX). At the transmitter side, a resonant cavity light emitting diode (RC-LED) is currently a widely used light source as it has high efficiency and wide modulation bandwidth but a relatively large divergence angle at 650 nm. The light pulse that propagates down the fiber undergoes both attenuation and dispersion. The typical value of attenuation is around 200 dB/km and the dispersion is approximately 100 ns/km. The typical optical receiver is thermal noise limited and employs high speed PIN photo detector that has high sensitivity and relatively large active area. A reliable POF data link would have low dispersion and a link budget that is higher than the total link loss at the specified data rate and link distance.

The main shortcoming of SI-POF is modal dispersion. Dispersion limits the bandwidth of SI-POF to approximately 10 MHz.km or 10 GHz.m. The dispersion-limited bandwidth of a 50 m fiber is therefore about 200 MHz, corresponding to a data rate of about 400 Mbps using non-return-to-zero (NRZ) pulse amplitude-shift keying (ASK). Several techniques to increase the data rate have been put forth both in electrical and optical domains. In the electrical domain, modulation and equalization techniques such as multilevel pulse amplitude modulation (M-PAM), multi-carrier OFDM modulation, as well as fixed and adaptive equalization have been developed. In the optical domain, spatial filtering techniques such as restricted mode launching and photo detectors with small active area have been developed.

Unfortunately, the current methods in the electrical domain involve complex signal processing and filtering techniques that result in high overall link cost. In the optical domain, current spatial filtering techniques have been effective but require high optical power, and necessitate complex procedures for fiber alignment and splicing.

### SUMMARY

The present disclosure provides systems and methods for mitigating modal dispersion in a step-index optical fiber (SI-OF) link using a mode dispersion reducing filter element. In certain embodiments, the filter element includes a structure having an internal cylindrical volume adapted to connect an end of one OF and an end of another OF with an air gap in between. Adjusting the distance of the air gap results in an adjustment of the effective numerical aperture (NA) of a propagating beam of light.

Various embodiments exploit the fact that higher-order modes in SI-OF propagate at steeper angles than the lower-order modes propagating at a low grazing angle. Due to the differential path lengths, the lower-order modes would exit the fiber before the higher-order modes, resulting in modal dispersion that causes the spreading of the output pulses arriving at the detector. This modal dispersion effect may be mitigated by eliminating the higher-order modes by means of spatial mode filtering prior to photo-detection.

According to an embodiment, an optical fiber link is provided that typically includes a first optical fiber (OF) having an exit end, a second OF having an entrance end, and a mode dispersion reducing element or device disposed between the exit end of the first OF and the entrance end of the second OF. The element typically includes a structure having an internal cylindrical volume connecting the exit end of the first OF with the entrance end of the second OF, wherein an index of refraction of the structure is greater than an index of refraction of a material within the internal cylindrical volume, and wherein a length of the internal cylindrical volume between the exit end of the first OF and the entrance end of the second OF defines an effective numerical aperture of the entrance end of the second OF.

According to another embodiment, an optical fiber link having a reduced numerical aperture is provided. The link typically includes a mode filter element comprising a tube having an inner diameter defining a substantially cylindrical internal surface and internal volume along an axis of the tube, wherein the filter element comprises a material having a first index of refraction higher than a second index of refraction of the internal volume. The optical fiber link also typically includes a first optical fiber (OF) inserted in a first end of the hollow tube, and a second OF inserted in a second end of the hollow tube opposite the first end, wherein a distance between ends of the first OF and the second OF within the hollow tube defines a gap width within the hollow tube. In operation, e.g., when light is introduced into an entrance end of the first OF, as an optical beam propagates from the first OF to the second OF within the tube, higher order modes of the optical beam having a higher propagating angle than a propagating angle of lower order modes of the optical beam are captured by the internal surface, and wherein an exit angle of lower order modes captured by the second end of the second OF is defined by the gap width.

According to yet another embodiment, an optical fiber link having a reduced numerical aperture is provided. The link typically includes a mode filter element comprising a tube having an inner diameter defining a substantially cylindrical internal surface and internal volume along an axis of the tube, wherein the filter element comprises a material having a first index of refraction higher than a second index of refraction of the internal volume. The optical fiber link also typically includes a first optical fiber (OF) inserted in a first end of the hollow tube, and a second OF inserted in a second end of the hollow tube opposite the first end, wherein a distance between ends of the first OF and the second OF within the hollow tube defines a gap width within the hollow tube. In operation, as an input optical beam propagates from the first OF to the second OF within the tube, higher order modes of the optical beam having a propagating angle that is less than a critical angle defined by a change of refractive index at the internal surface from the second index of refraction to the first index of refraction are captured by the internal surface, and wherein an exit angle of lower order modes having a propagating angle that exceeds the critical angle are captured by the second end of the second OF, wherein the exit angle is defined by the gap width and the inner diameter.

According to yet a further embodiment, a method of reducing the effective numerical aperture (NA) of an optical fiber (OF) link is provided. The method typically includes inserting a first end of a first optical fiber (OF) into a first end of a hollow tube structure having an inner diameter, the inner diameter defining a substantially cylindrical internal volume along an axis of the hollow tube, the hollow tube structure formed of a first material having an index of refraction higher than an index of refraction of a second material within the internal volume, inserting a second end of a second OF into a second end of the hollow tube opposite the first end, wherein a distance between the first end of the first OF and the second end of the second OF within the hollow tube defines a gap width within the hollow tube, and introducing light into an entrance end of the first OF, wherein an acceptance angle of light at the second end of the second OF is defined by the gap width. The introduced light may include coherent light (e.g., from a laser source) or non-coherent light (e.g., from an LED or other source). In certain aspects, the method includes adjusting the gap width by adjusting, manually or automatically, a position of one or both of the first end of the first OF and the second end of the second OF within the hollow tube. In certain aspects, the first material comprises a plastic material, and the second material comprises a gaseous medium. In certain aspects, the method further includes cutting a single OF to form the first OF and the second OF. The method may also include detecting a signal sent (e.g., by modulating light introduced into first OF) by a transmitter device coupled with the first OF and received at a receiver device coupled with the second OF.

In certain aspects, each of the first and second OFs includes a plastic optical fiber (POF) or a silica optical fiber (SOF). In certain aspects, each of the first and second OFs includes a step-index optical fiber (SI-OF). In certain aspects, each of the first and second OFs comprises a step index plastic optical fiber (POF). In certain aspects, each of the first and second OFs has a diameter of about 1 mm.

In certain aspects, the structure comprises a plastic material. In certain aspects, the plastic material comprises PMMA. In certain aspects, the material within the internal cylindrical volume comprises a gaseous medium.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE SEVERAL VIEWS OF THE DRAWING(S)

The detailed description is described with reference to the accompanying figures. The use of the same reference numbers in different instances in the description and the figures may indicate similar or identical items.

FIG. 1 shows a capillary tube holding two ends of SI-POF pieces according to an embodiment.

FIG. 2 shows propagation of tow modes inside a fiber.

FIG. 3 shows an input signal applied to a SI-POF and an output signal.

FIG. 4 shows a frequency domain representation of the SI-POF dispersive impulse response.

FIG. 5 shows an example of pulse spreading due to modal dispersion.

FIGS. 6 and 7 show different views of a configuration of a spatial mode filter according to an embodiment.

FIG. 8 shows an experimental setup with a 1 Gbps Ethernet evaluation board.

FIG. 9 shows a plot of measured beam divergence (angle) as the gap width varies.

FIG. 10 shows the beam profile at the receiver before and after the spatial mode filter with a 3 mm gap.

FIG. 11 shows a plot of received optical power as the gap width varies.

FIG. 12 shows a plot of bit-error rate as the gap width varies.

FIG. 13 shows an eye diagram at 1 Gbps with a 3 mm gap.

FIG. 14 shows frequency response curves with and without spatial mode filtering.

### DETAILED DESCRIPTION

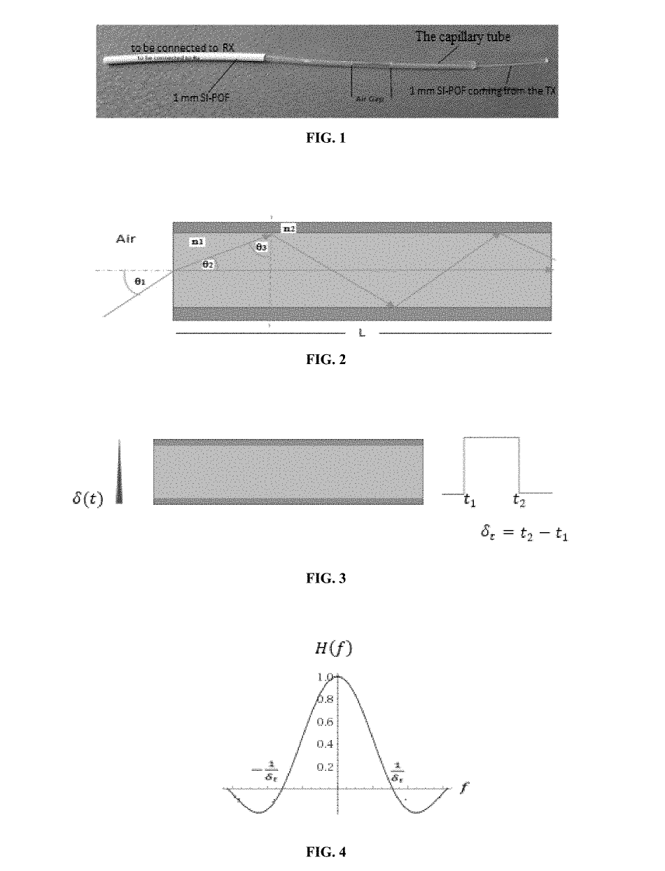

In various embodiments, efficient devices and techniques are provided that are directed to mitigating the modal dispersion in an optical fiber link by reducing the effective numerical aperture (NA) of the fiber link. The techniques in certain embodiments involve a spatial mode filter that is constructed using a plastic structure, e.g., polycarbonate, capillary tube having a refractive index of 1.59, with inner and outer diameters of 1 mm and 2 mm, respectively. As shown in FIG. 1, the capillary tube holds two pieces of SI-POF (e.g., 1 mm SI-POF); one fiber is connected to the transmitter and the other fiber is connected to the receiver. The two fibers are aligned by the tube and separated by an air gap. It will be appreciated that 1 mm SI-POF is merely an example and that various embodiments contemplate POF fibers of differing types and dimensions including silica optical fibers (SOFs). For example, dimensions (e.g., cross sectional diameters) of optical fibers may range from about 9/125 microns to about 1 mm or greater. In some embodiments, the two fibers may have different diameters, e.g., the tube structure may taper in diameter or have a discrete change in diameter.

When an optical pulse is launched into a SI-OF, different modes take different paths through the fiber. The fiber modes that take a shorter path arrive at the receiving end before those that had taken a longer path. The difference in the arrival time causes pulse spreading or time dispersion. FIG. 2 shows the time t₁ taken by the axial mode to reach the receiver which can be calculated as:

$${t}_{1} = \frac{{n}_{1} L}{c} \qquad ( 1 )$$

where L is the length of fiber link, c is the speed of light, and n₁ is the refractive index of the fiber core.

The time it takes the mode that makes an angle θ₂ with the horizontal axis to arrive at the receiver is calculated as follows:

$${t}_{2} = \frac{L {n}_{1}}{c cos {θ}_{2}} \qquad ( 2 )$$

Applying Snell's law to the light rays of FIG. 2 gives: n₁ sin θ₃=n₂ sin 90 or

$$sin {θ}_{3} = \frac{{n}_{2}}{{n}_{1}} ,$$

assuming that θ₃ is equal to the critical angle. Also, with

$$cos {θ}_{2} = sin {θ}_{3} = \frac{{n}_{2}}{{n}_{1}} \text{:} {t}_{2} = \frac{L {n}_{1}^{2}}{{cn}_{2}} \qquad ( 3 )$$

The time delay difference between t₂ and t₁, i.e., the delay spread, is given by:

$${δ}_{t} = {t}_{2} - {t}_{1} = \frac{L {n}_{1}^{2}}{{cn}_{2}} - \frac{L {n}_{1}}{c} = \frac{L {n}_{1}^{2}}{{cn}_{2}} ( \frac{{n}_{1} - {n}_{2}}{{n}_{1}} ) \qquad ( 4 )$$

With NA=(n²_{core}−n²_{cladding})^{1/2}, and taking n₁≈n₂, the NA can be determined as:

$$\frac{{NA}^{2}}{2 {n}_{1}^{2}} = \frac{{n}_{1} - {n}_{2}}{{n}_{1}} \qquad ( 5 )$$

Combining Equations (4) and (5) shows that:

$${δ}_{t} = \frac{{LNA}^{2}}{2 {n}_{1} c} or \frac{{δ}_{t}}{L} = \frac{{NA}^{2}}{2 {n}_{1} c} where \frac{{δ}_{t}}{L} \qquad ( 6 )$$

is the modal dispersion in seconds per meter.

Equation (6) shows that reducing the NA by a factor of two would reduce the delay spread effect of modal dispersion by a factor of four.

The number of modes N in SI-POF can be approximated as:

$$N = \frac{{V}^{2}}{2} \qquad ( 7 )$$

where V is the normalized frequency which is given by:

$$V = \frac{2 π a}{λ} \sqrt{{n}_{1}^{2} - {n}_{2}^{2}} = \frac{2 π a}{λ} NA \qquad ( 8 )$$

Combining Equation (7) and (8), the number of modes in terms of NA is calculated as follows:

$$N = {( \frac{2 π a}{λ} )}^{2} {( NA )}^{2} \qquad ( 9 )$$

Again, it is clear that reducing the NA by one-half results in mode reduction by a factor of four.

Suppose that an impulse signal is applied to the SI-POF as shown in FIG. 3. The output signal can be modeled as a rectangular pulse with a width δₜ (assuming that the mode mixing and the mode dependent attenuation are negligible).

The impulse response of the system is:

$$h ( t ) = \{ \begin{matrix}1 & for {t}_{1} \leq t \leq {t}_{2} \\ 0 & elsewhere\end{matrix} \qquad ( 10 )$$

Applying a Fourier transform to the impulse response gives:

H(f)=sin c(fδₜ) (11)

A graphical representation of the transfer function H(f) is shown in FIG. 4.

As can be seen, the first null bandwidth of the system is

$$\frac{1}{{δ}_{t}} .$$

Based on the previous analysis, the bandwidth of the SI-POF can be calculated in terms of NA as illustrated in Equation (12).

$$BW = \frac{1}{{δ}_{t}} = \frac{2 {cn}_{1}}{{L ( NA )}^{2}} \qquad ( 12 )$$

This shows that reducing the NA by a factor of two would improve the bandwidth by a factor of four.

According to the ray theory of wave propagation, the higher order modes in a multimode fiber propagate with a steep angle that is close to the critical angle, while the lower order modes propagate at a low grazing angle. FIG. 5 shows an example of pulse spreading due to modal dispersion. Due to the differential path lengths as illustrated in FIG. 5, the lower order modes would exit the fiber before the higher order modes, resulting in modal dispersion that causes the spreading of the output pulses.

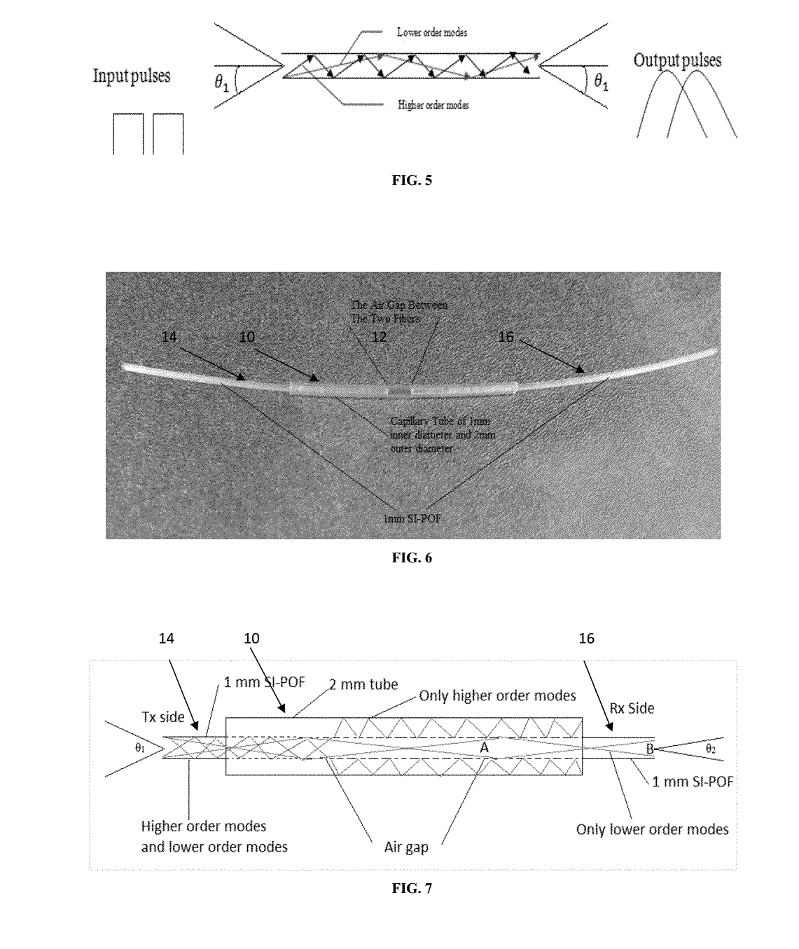

FIG. 6 and FIG. 7 show views of a configuration of a spatial mode filter 10 according to an embodiment. The filter 10 is comprised of a structure having an inner volume that defines an axis of propagation for a light beam. In certain embodiments, the inner volume has a circular cross section such as to define a cylindrical shaped tube or inner volume. In other embodiments, the inner volume may have a rectangular or oval cross section. The structure may be made of a plastic or other material having a higher index of refraction than the inner volume, which may be air or another material. An example structure according to an embodiment includes a plastic, e.g., polycarbonate (1.59 refractive index), tube structure having a cylindrical, hollow inner volume such as a capillary tube that has inner and outer diameters (e.g., of 1 mm and 2 mm, respectively). Other plastics or other materials may be used to form filter 10. Two fiber links (e.g., 1 mm fibers) from TX and RX sides or components are inserted into the tube with an air gap 12 separating the two ends as shown. Not shown are the transmission and the receiver components. The transmission components may include a light source and other optical elements as may be desired to guide and condition the light emitted by the light source and to couple the light emitted by the light source to an optical fiber. The light source may include a coherent light source such as a diode laser or other laser, or a non-coherent light source such as an LED or other source. The receiver may include a photodetector such as a photodiode or other light detection element.

The width of the air gap 12 can be adjusted by pulling apart or pushing together, manually or automatically, the two fiber ends 14 and 16 inside the tube structure. FIG. 7 illustrates that as the propagating optical beam exits the left fiber 14 and travels across the gap 12 between the two fibers 14 and 16, the higher order modes, owing to their steep propagating angle θ₁, would reach the interface between the air gap and the inner surface of the tube, and would be captured by the tube due to its larger index of refraction than the material within the inner volume, e.g., air or other gaseous medium or plastic medium having a lower index of refraction than the index of refraction of the tube structure.

The lower order modes, owing to their low grazing propagating angle, would continue across the gap reaching and being captured by the right fiber 16 at point A shown in FIG. 7. As a result, the angle of incidence θ₂ at point A is smaller than θ₁. It is clear that θ₂ will become smaller as the air gap separation increases. For a short exit fiber, the incident beam angle θ₂ on the detector is approximately equal to the beam angle at point A which becomes smaller as the air gap increases.

The angle at point A is equal to the angle θ₂. Equation (6), at point A and B, can be rewritten as:

$$\frac{{δ}_{t}}{L} = \frac{{effectiveNA}^{2}}{2 cn} = \frac{{( sin {θ}_{2} )}^{2}}{2 cn} \qquad ( 13 )$$

where n is the refractive index of the core material. The number of modes can be also be approximated as:

$$N = 2 {( \frac{2 π a \times sin {θ}_{2}}{λ} )}^{2} \qquad ( 14 )$$

The bandwidth can then be determined in terms of the effective numerical aperture as:

$$BW = \frac{2 {cn}_{1}}{{L ( sin {θ}_{2} )}^{2}} \qquad ( 15 )$$

The improvement in the bandwidth due to the spatial mode filtering is given by:

$${BW}_{2} = {BW}_{1} \times {( \frac{{NA}_{1}}{{NA}_{2}} )}^{2} \qquad ( 16 )$$

where BW₁ and NA₁ are the bandwidth and NA before using the filter, and BW₂ and NA₂ are the bandwidth and NA after using the filter.

From equations (13), and (14), one can conclude that the dispersion and the number of modes can be reduced significantly by reducing the effective numerical aperture sin θ₂. The effective numerical aperture can be decreased by increasing the gap width between the two fibers inside the tube structure. The filter therefore reduces the effective numerical aperture by increasing the air gap width.

The power lost because of the reduction of the numerical aperture can be approximated by:

$$Loss ( dB ) = 20 log ( \frac{{NA}_{1}}{{NA}_{2}} ) \qquad ( 17 )$$

Thus, reducing the numerical aperture by a factor of two would lead to a factor of four in bandwidth improvement while incurring a 6 dB of power loss to the system.

The reduction of the NA of a fiber link has a great impact on the link bandwidth. Certain embodiments can control the NA of the SI-OF link by means of a spatial mode filter that employs a tube structure with an inner cylindrical diameter, e.g., capillary tube, with inner and outer diameters of 1 mm and 2 mm, respectively. The ends of two OF links are inserted into the tube structure which allows an air gap to separate the two ends. The width of the air gap, and hence the NA, can be adjusted by pulling apart or pushing together the two fiber ends inside the capillary tube.

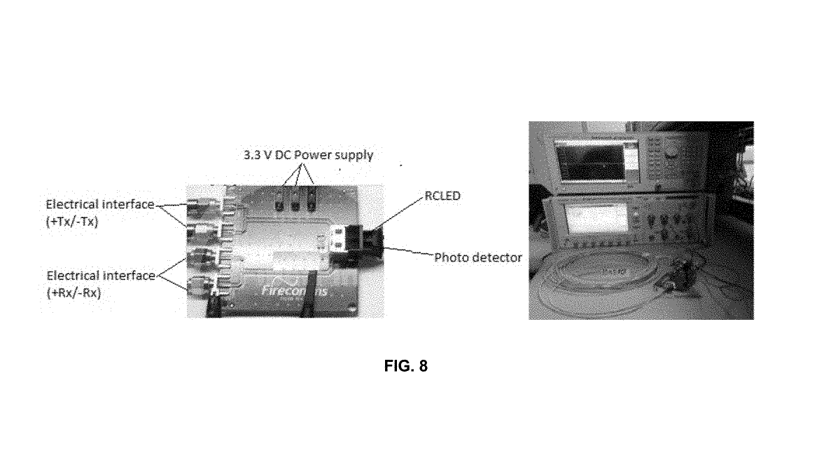

FIG. 8 show the experimental setup with a 1 Gbps Ethernet evaluation board (Firecomms FF-EVAL-FB01GKVR). The board includes a high speed RCLED operating at 650 nm with an output power of +0 dBm, and a high speed photo-detector having a sensitivity of −13 dBm with an active area of 400 μm in diameter. An Agilent 86130A bit-error rate (BER) analyzer was used to evaluate the performance of the link that employed NRZ signaling over a standard 1 mm POF link that was 30 m in length.

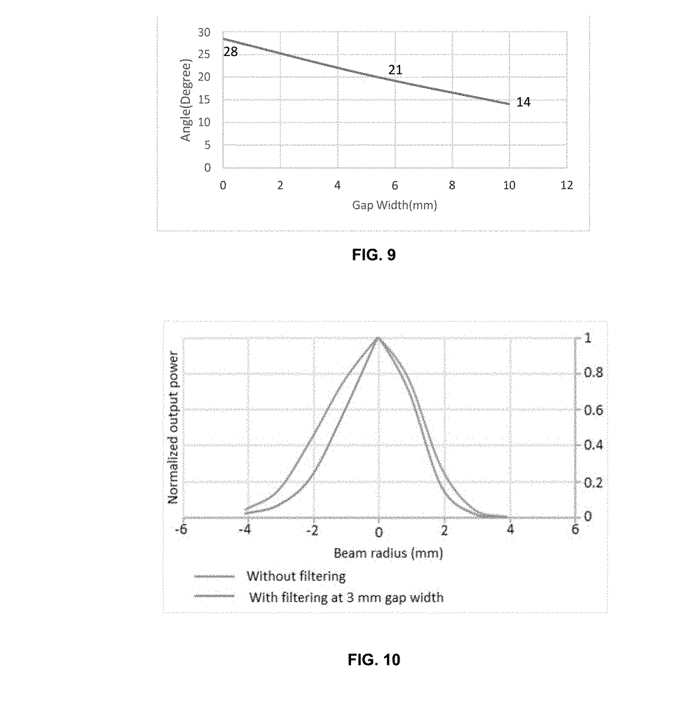

FIG. 9 plots the measured beam divergence angle at the output fiber as the gap width varies. As can be seen, the divergence angle and hence the NA decreases by nearly 50% over the range of the gap width.

FIG. 10 shows the beam profile at the receiver before and after the spatial mode filter with a 3 mm gap. The beam profiles demonstrated a reduction of the beam waist by about 20% with the spatial mode filter.

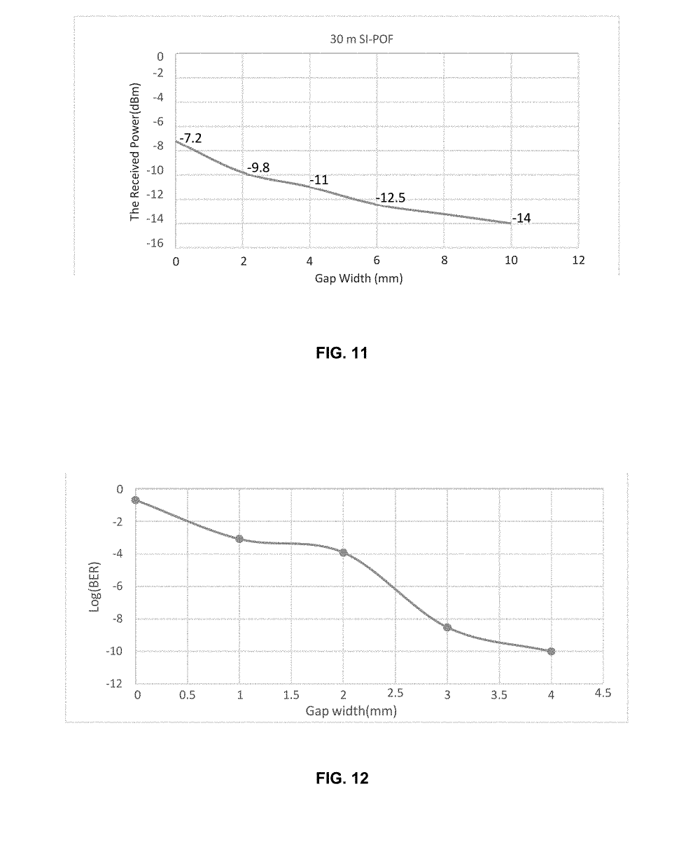

FIG. 11 shows that the received power loss over a 10 mm range of gap width can be as much as 7 dB. The power loss for a 3 mm gap width is about 3 dB.

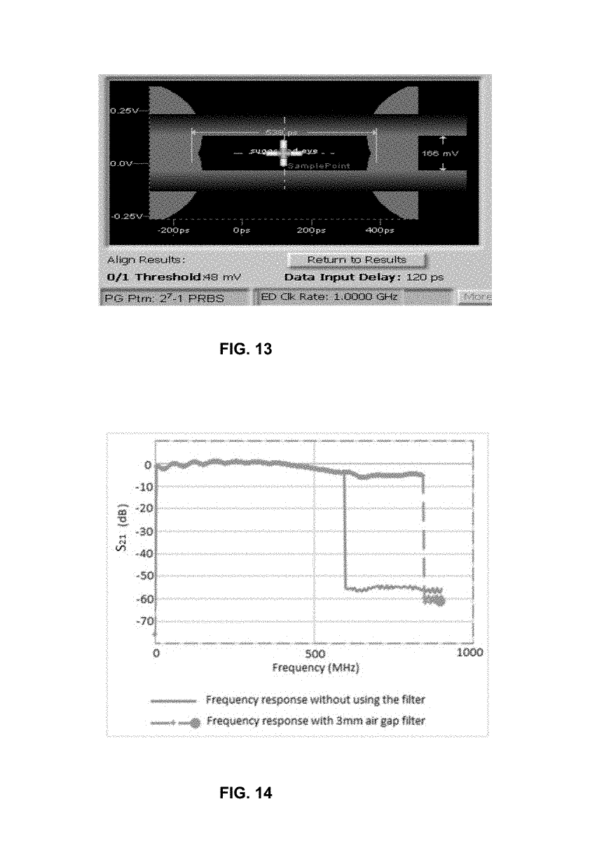

FIG. 12 plots the measured BER performance versus the gap width at an NRZ data rate of 1 Gbps. The BER was about 10⁻¹ with zero air gap (no filtering), and improved to less than 10⁻⁸ with a 3 mm gap. The corresponding eye diagram with the 3 mm gap is displayed in FIG. 13. The eye is open clearly with no inter-symbol interference (ISI) that would be indicative of modal dispersion.

Adjusting the NA has also shown a significant improvement of the frequency response of the entire system as shown in FIG. 14, illustrating a 36% improvement in the bandwidth from about 600 MHz to 820 MHz.

The present embodiments advantageously mitigate the effect of modal dispersion by reducing the effective NA of the fiber link. Certain embodiments include a spatial mode filter that is constructed using a plastic structure such as a polycarbonate capillary tube having a refractive index of 1.59, with inner and outer diameters of 1 mm and 2 mm, respectively. The capillary tube holds two pieces of 1 mm SI-POF, one fiber connecting to the transmitter and the other fiber connecting to the receiver. The filter is positioned near the receiver, with the two fibers aligned by the tube and separated by an air gap. Increasing the gap width effectively reduces the NA of the fiber link.

An embodiment has been demonstrated experimentally to reduce the BER over a 30 m link, achieving a BER of 10⁻⁸ at 1 Gbps. The gap width of the spatial mode filter can control the effective NA, thereby reducing the dispersion. This approach offers a simple and a cost-effective solution to achieve data rate of a 1 Gbps over 30 m of standard 1 mm SI-POF.

It is expected that 1 Gbps over 50 m of standard SI-POF can be achieved using a transceiver that has a link budget of at least 17 dB in order to accommodate the power penalty determined from FIG. 11. The embodiments can also be combined with channel equalization that would further mitigate modal dispersion, thereby simplifying the required signal processing and providing a cost-effective implementation.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An optical fiber link comprising:
a first optical fiber (OF) having an exit end;
a second OF having an entrance end; and
a mode dispersion reducing element disposed between the exit end of the first OF and the entrance end of the second OF, the element comprising a structure having an internal cylindrical volume connecting the exit end of the first POF with the entrance end of the second OF,
wherein an index of refraction of the structure is greater than an index of refraction of a material within the internal cylindrical volume, and wherein a length of the internal cylindrical volume between the exit end of the first OF and the entrance end of the second OF defines an effective numerical aperture of the entrance end of the second OF.

2. The optical fiber link of claim 1, wherein the structure comprises a plastic material.

3. The optical fiber link of claim 2, wherein the plastic material comprises PMMA.

4. The optical fiber link of claim 1, wherein the material within the internal cylindrical volume comprises a gaseous medium.

5. The optical fiber link of claim 1, wherein each of the first and second OFs comprise a step index plastic optical fiber (POF).

6. An optical fiber link having reduced modal dispersion, the link comprising:
a mode filter element comprising a tube having an inner diameter defining a substantially cylindrical internal surface and internal volume along an axis of the tube, wherein the filter element comprises a material having a first index of refraction higher than a second index of refraction of the internal volume;
a first optical fiber (OF) inserted in a first end of the hollow tube; and
a second OF inserted in a second end of the hollow tube opposite the first end, wherein a distance between ends of the first OF and the second OF within the hollow tube defines a gap width within the hollow tube;
wherein as an input optical beam propagates from the first OF to the second OF within the tube, higher order modes of the optical beam having a higher propagating angle than a propagating angle of lower order modes of the optical beam are captured by the internal surface, and wherein an exit angle of lower order modes captured by the second end of the second OF is defined by the gap width.

7. The optical fiber link of claim 6, wherein the material comprises a plastic material.

8. The optical fiber link of claim 7, wherein the plastic material comprises PMMA.

9. The optical fiber link of claim 6, wherein the internal volume comprises a gaseous medium.

10. The optical fiber link of claim 6, wherein each of the first and second OFs comprise a step index plastic optical fiber (POF).

11. An optical fiber link having reduced modal dispersion, the link comprising:
a mode filter element comprising a tube having an inner diameter defining a substantially cylindrical internal surface and internal volume along an axis of the tube, wherein the filter element comprises a material having a first index of refraction higher than a second index of refraction of the internal volume;
a first optical fiber (OF) inserted in a first end of the hollow tube; and
a second OF inserted in a second end of the hollow tube opposite the first end, wherein a distance between ends of the first OF and the second OF within the hollow tube defines a gap width within the hollow tube;
wherein as an input optical beam propagates from the first OF to the second OF within the tube, higher order modes of the optical beam having a propagating angle that is less than a critical angle defined by a change of refractive index at the internal surface from the second index of refraction to the first index of refraction are captured by the internal surface, and wherein an exit angle of lower order modes having a propagating angle that exceeds the critical angle are captured by the second end of the second OF, wherein the exit angle is defined by the gap width and the inner diameter.

12. The optical fiber link of claim 11, wherein the material comprises a plastic material.

13. The optical fiber link of claim 12, wherein the plastic material comprises PMMA.

14. The optical fiber link of claim 11, wherein the internal volume comprises a gaseous medium.

15. The optical fiber link of claim 11, wherein each of the first and second OFs comprise a step index plastic optical fiber (POF).

16. A method of reducing the effective numerical aperture (NA) of an optical fiber (OF) link, the method comprising:
inserting a first end of a first optical fiber (OF) into a first end of a hollow tube structure having an inner diameter, the inner diameter defining a substantially cylindrical internal volume along an axis of the hollow tube, the hollow tube structure formed of a first material having an index of refraction higher than an index of refraction of a second material within the internal volume;
inserting a second end of a second OF into a second end of the hollow tube opposite the first end, wherein a distance between the first end of the first OF and the second end of the second POF within the hollow tube defines a gap width within the hollow tube,
introducing light into an entrance end of the first OF, wherein an acceptance angle of light at the second end of the second OF is defined by the gap width.

17. The method of claim 16, further comprising adjusting the gap width by adjusting a position of one or both of the first end of the first OF and the second end of the second OF within the hollow tube.

18. The method of claim 16, wherein the first material comprises a plastic material, and wherein the second material comprises a gaseous medium.

19. The method of claim 16, further comprising cutting a single OF to form the first OF and the second OF.

20. An optical fiber (OF) spatial mode filter element comprising a structure having an internal cylindrical volume and adapted to connect an exit end of a first OF with an entrance end of a second OF, wherein an index of refraction of the structure is greater than an index of refraction of a material within the internal cylindrical volume, and wherein when disposed between the exit end of the first OF with the entrance end of the second OF a width of the hollow volume between the exit end of the first OF and the entrance end of the second OF defines an effective numerical aperture of the entrance end of the second OF.
